(19) United States
(12) Patent Application Publication
(10) Pub. No.: US 2022/0357919 A1
(43) Pub. Date: Nov. 10, 2022

(54) Numeric Operations on Logarithmically Encoded Data Values

(71) Applicant: Oracle International Corporation, Redwood City, CA (US)

(72) Inventor: Daniel Goodman, Bagillt (GB)

(21) Appl. No.: 17/315,103

(22) Filed: May 7, 2021

(51) Int. Cl. G06F 7/483; G06F 7/485; G06F 7/499

(52) U.S. Cl. CPC G06F 7/4833; G06F 7/485; G06F 7/4991

(57) ABSTRACT

Numeric operations on a series of values, each encoded as a logarithm, may be performed. A first offset is determined based on values of an initial subset of the series. Numerical operations on individual elements of the series may then be performed by performing an exponentiation of a difference between the individual elements and the first offset. A particular element in the series may be identified as being unable to be included without causing an overflow or underflow of an exponentiation or numerical operation. In this event, a second offset may be determined. The numerical operations may then proceed by adjusting a current accumulated result using the second offset and continuing to perform numerical operations on individual elements of the series by performing an exponentiation of a difference between the individual elements and the second offset. Additional offsets may be optionally determined until the numerical operation is complete.

### BACKGROUND

### Field of the Disclosure

This disclosure relates generally to computer software, and more particularly to systems and methods for performing arithmetic computations on data values over a potentially wide numerical range.

### Description of the Related Art

When performing numerical operations, it is not uncommon to find situations where standard numeric encodings, for example IEEE double precision floating point encodings, are unable to represent sufficiently large or small numbers resulting in out-of-range conditions such as overflow or underflow. One technique to overcome this is to move from a normal, or linear, numeric encoding to logarithmic, or log, encoding where a logarithmic value of a number is used instead of a linear value of the same number.

### SUMMARY

Methods, techniques and systems for providing improved numeric operations, such as addition and subtraction, of numbers encoded as logarithms are disclosed. For example, a summation of a series of values, each encoded as a logarithm, may be performed. A first offset value is determined based on values of an initial subset of the series. Individual elements of the series may be added to an accumulator by performing an exponentiation of the difference between the logarithmic values and the first offset value. A particular value in the series may be identified as being unable to be added without causing an out-of-range error in an exponentiation or summing operation. In this event, a new offset value may be determined. The summation may then proceed by adjusting the current accumulator using the new offset value and continuing to add individual elements of the series by performing an exponentiation of the difference between the logarithmic values and the new offset value. Additional offsets may be optionally determined until the summation is complete.

### BRIEF DESCRIPTION OF THE DRAWINGS

FIG. 1 is a block diagram illustrating a system implementing improved numerical operations, such as summations, operating on logarithmically encoded data values, according to some embodiments.

FIG. 2 is a flow diagram illustrating an embodiment implementing summation of a series of logarithmically encoded data values, according to some embodiments.

FIG. 3 is a flow diagram illustrating another embodiment of an improved method of implementing summation of a series of logarithmically encoded data values, according to some embodiments.

FIG. 4 is a flow diagram illustrating an embodiment of an improved method of implementing numeric operations on a stream of logarithmically encoded data values, according to some embodiments.

FIG. 5 is a flow diagram illustrating various embodiments of a method for determining if a new offset value is used for summation, according to some embodiments.

FIG. 6 is a block diagram illustrating one embodiment of a computing system that implements summation of logarithmically encoded data values, according to some embodiments.

While the disclosure is described herein by way of example for several embodiments and illustrative drawings, those skilled in the art will recognize that the disclosure is not limited to embodiments or drawings described. It should be understood that the drawings and detailed description hereto are not intended to limit the disclosure to the particular form disclosed, but on the contrary, the disclosure is to cover all modifications, equivalents and alternatives falling within the spirit and scope as defined by the appended claims. Any headings used herein are for organizational purposes only and are not meant to limit the scope of the description or the claims. As used herein, the word “may” is used in a permissive sense (i.e., meaning having the potential to) rather than the mandatory sense (i.e. meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. § 112(f) interpretation for that unit/circuit/component.

This specification includes references to “one embodiment” or “an embodiment.” The appearances of the phrases “in one embodiment” or “in an embodiment” do not necessarily refer to the same embodiment, although embodiments that include any combination of the features are generally contemplated, unless expressly disclaimed herein. Particular features, structures, or characteristics may be combined in any suitable manner consistent with this disclosure.

### DETAILED DESCRIPTION OF EMBODIMENTS

When performing numerical operations, it is not uncommon to find situations where standardized numeric encodings, regardless of precision, are unable to represent sufficiently large or small numbers, resulting in out-of-range conditions such as overflow or underflow. One technique to overcome this is to move from a normal, or linear, numeric encoding to logarithmic, or log, encoding where a logarithmic value of a number is used instead of a linear value of the same number. In many cases, such as in statistical modeling and machine learning, working with logarithmic encodings is often preferred, as certain mathematical operations may be easier to perform with log encodings than with linear ones. Some mathematical operations, however, such as summations, cannot be directly performed using log encodings and therefore use temporary conversions of log values back into linear values to perform computations. These temporary conversions may, however, result in out-of-range errors if the encoding format used is unable to handle the range of linear values present.

Modern computer systems conventionally include the ability to process data using a variety of numeric formats, including integers, fixed point numbers and standardized floating point numbers, where these formats may further be encoded in several sizes to provide flexibility regarding precision, performance, storage space and numerical range of values. Standardized floating point numbers are represented using industry standard formats to provide consistency and interchangeability across a variety of processor architectures. These industry standard floating point formats typically include a data structure defining three bit fields, a single sign bit indicating whether the value is positive or negative, a fractional field indicating a range from zero to one, and an exponent field representing an order of magnitude for the value. In this way, relatively compact representations of values may be employed having a range of values far wider than conventional integer encodings while sacrificing only modest precision.

Fixed length number encodings have a fixed numeric range. Computations may result in range requirements well in excess of the supported range. In these applications, storing the logarithm of the value, logarithmic encoding, can greatly expand the range of possible values compared with just storing the values directly, linear encoding, for the same numeric encoding This also increases the computational efficiency of certain mathematical operations such as multiplication and division.

In logarithmic encoding, multiplication and division may be replaced with addition and subtraction respectively. However, when performing addition or subtraction on a sequence of numbers, x₁ . . . xₙ, there is no corresponding operation in logarithmic encoding. To perform addition on the sequence of numbers, linear encoding may be used by performing the calculation xₛᵤₘ=log_{b}(b^{x}^{₁}+b^{x}^{₂}+ . . . +b^{x}^{ₙ}), where b is the base for the logarithmic encoding. These calculations, however, may suffer from the same out-of-range concerns as described above due to the greater numerical range. A technique to overcome this is to employ an offset, such as xₛᵤₘ=log_{b}(b^{x}^{₁}^{-x}^{_{*}}+b^{x}^{₂}^{-x}^{_{*}}+ . . . +b^{x}^{ₙ}^{-x}^{_{*}})+x_{*} where x_{*}=max(x₁, x₂, . . . , xₙ).

By offsetting the range of the linear encoded values, techniques may address the out-of-range issues using a maximal value. This technique, however, may cause all linearly encoded values to be stored, taking linear storage, and iterating through the linearly encoded values, which takes linear time. The situation may be made worse when the number of values exceeds the size of the caches as the speed of the memory accesses may be significantly impacted.

It should be noted that while logarithmic encoding may be used with floating point formats, logarithmic encoding is not limited to floating point formats and may be used with other formats including integer and fixed point numbers. Furthermore, linear encoded values and logarithmic encoded values may use different encodings in various embodiments, including combinations of integer, fixed-point or floating point encodings and/or differing encoding lengths for the linear and logarithmic encodings. In the various examples disclosed herein, floating point encodings are used, however these examples are not intended to be limiting and the various techniques may also to apply to other numeric encoding techniques.

It should also be noted that while the various example numerical operations disclosed herein are directed to summations of positive logarithmically encoded values, these examples are not intended to be limiting and various other numerical operations may be envisioned. Furthermore, logarithmically encoded values may include both positive and negative values, where conversions between linear and logarithmic encodings consider only the respective magnitudes, or absolute values, of the data while preserving signs of the respective data values. In this way, the various techniques described herein may be applicable to a variety of numerical operations.

Techniques for improved numerical operations, such as summations, operating on logarithmically encoded data values are described herein. Improved numerical operations on logarithmically encoded data values may improve the performance of a computer system or device, thus lowering storage utilization and lower processor utilization. For example, improved summation of logarithmically encoded data values may reduce storage from linear storage utilization according to the number of values down to a small constant space utilization. This constant space utilization may be beneficial in many scenarios, such as when performing summations of logarithmically encoded data values on devices such as GPUs where storage constraints can limit which algorithms can be executed, such as Monte Carlo simulations that compute millions of values. The storage savings of improved summation of logarithmically encoded data values can therefore allow for the execution of algorithms on devices that would otherwise be unable to execute the algorithms.

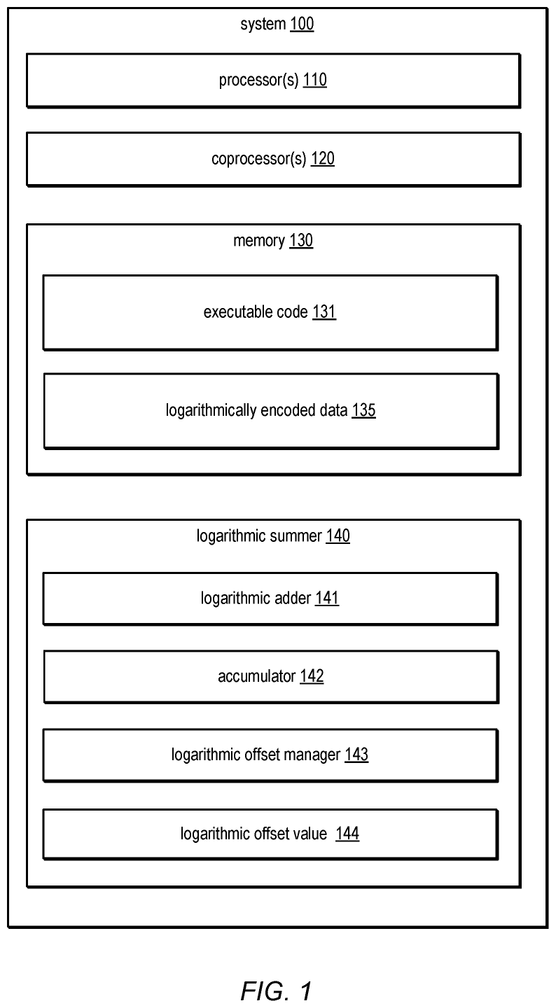

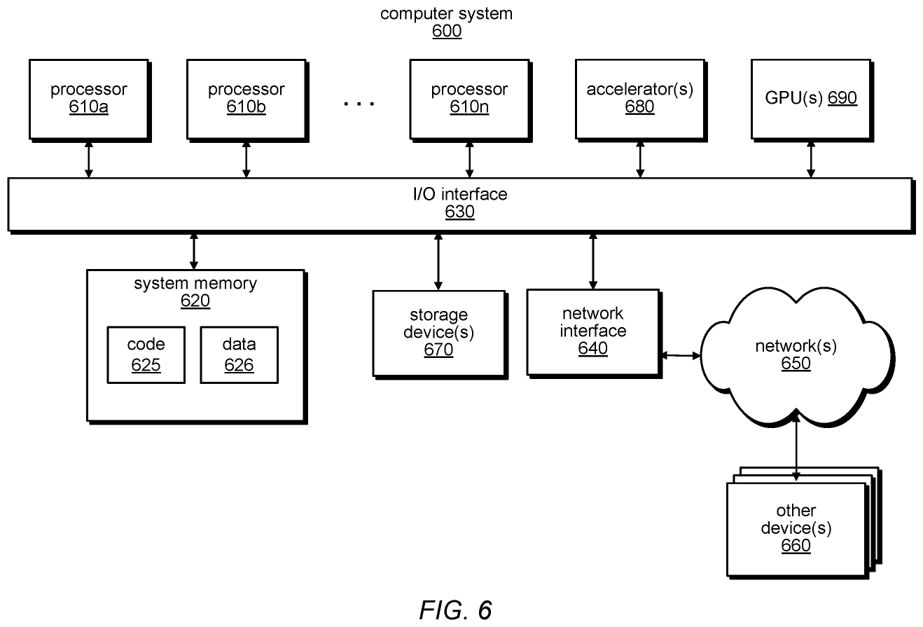

In another example, improved numerical operations on logarithmically encoded data values may reduce processor and memory bandwidth requirements. For instance, if a large but unknown number of values are to be produced and summed, conventionally this would require at least two and possibly three passes over the data, one to store the values, one to calculate the offset value, and one to perform the summation. As the number of values that will need to be stored is also unknown this could also require repeated memory allocations, and if the size of the stored variables exceeds the size of any processor cache, will require access to main memory. With improved numerical operations on logarithmically encoded data this can be reduced to a single pass with small constant storage requirements. By reducing the number of passes over the data and eliminating the need to store all values, processor requirements and memory bandwidth requirements can be decreased, increasing the speed at which computing systems or devices implementing improved numerical operations on logarithmically encoded data values may execute various applications. FIG. 1 is a block diagram illustrating a system implementing improved numerical operations, such as summations, operating on logarithmically encoded data values in various embodiments. A system 100 may include one or more processors 110 capable of executing code 131 stored in a memory 130. In addition, the system may further include one or more coprocessors 120 implementing various components of a logarithmic summer 140. These coprocessors 120 may execute additional code 131, for example using graphics processing units (GPUs), or may be implemented directly in circuitry, such as using custom logic, processor extensions, or using field programmable gate arrays (FPGAs). An exemplary system 100 is discussed in further detail below in FIG. 6.

The system 100 may include, in some embodiments, a series of logarithmically encoded data values 135 stored in the memory 130. In other embodiments, only a portion of a series of logarithmically encoded data values may be stored in the memory 130, while in still other embodiments logarithmically encoded data values may be received as a stream of sequentially accessed values with only a small number, or even only one, value stored in the memory 130 at any given time. These data configurations, however, are not intended to be limiting and any number of arrangements can be envisioned depending on particular application and the size of the data sets used.

The system 100 may further include a logarithmic summer 140 to implement improved summation of logarithmically encoded data values. This logarithmic summer 140 may provide a logarithmic adder 141 and logarithmic offset manager 143 and access an accumulator 142 and logarithmic offset value 144. The accumulator 142 and logarithmic offset value 144 may be individually implemented in the memory 130 or in custom circuitry in various embodiments, while the logarithmic adder 141 and logarithmic offset manager 143 may be individually implemented in executable code 131 or in custom circuitry in various embodiments.

In various embodiments, improved summation of logarithmically encoded data values may be implemented using the logarithmic summer 140. To implement such summations, the logarithmic summer 140 may create and maintain a current offset value stored in the logarithmic offset value 144 that may be used by the logarithmic adder 141 to incrementally added individual logarithmically encoded data values to the accumulator 142. Once all data values in the stream or series of logarithmically encoded data 135 have been added by the logarithmic adder 141 to the accumulator 142, the logarithmic summer 140 may then logarithmically encode the result in the accumulator 140 and added the current offset value stored in the logarithmic offset value 144 to generate the summation.

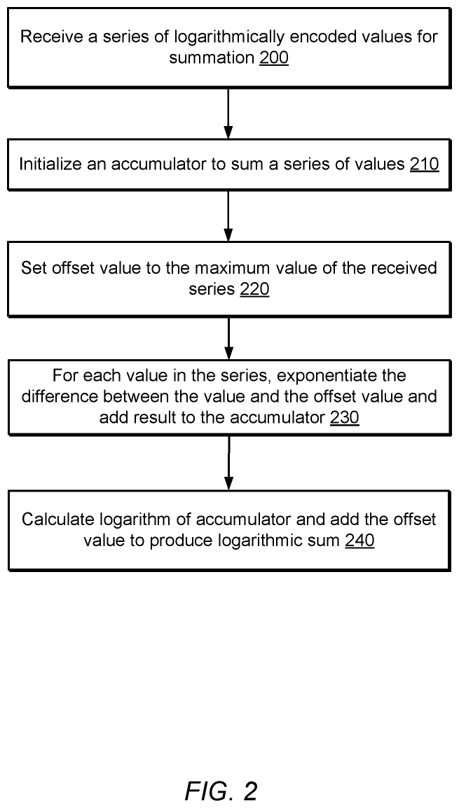

FIG. 2 is a flow diagram illustrating a summation of a series of logarithmically encoded data values. The process begins at step 200 where a series of logarithmically encoded data values may be received for summation, such as the logarithmically encoded data 135 as shown in FIG. 1. The process then initializes an accumulator, such as the accumulator 142 as shown in FIG. 1, with a zero value as shown in step 210 in some embodiments. As logarithmically encoded values may not be directly added, each logarithmically encoded value in the series may first be transformed into a linearly encoded value before being added to a sum.

If the transformations between logarithmic space and linear space are directly performed this could result in out-of-range conversion errors due to the relatively limited range for the resulting linearly encoded values, and subsequent summation may also result in similar out-of-range errors. Instead, an offset value, such as the logarithmic offset value 144 as shown in FIG. 1, may first be determined, for example by the logarithmic offset manager 143 of FIG. 1, by selecting the highest valued, or maximum value, of the series of logarithmically encoded data values and assigning the offset value to that maximum value, in some embodiments, as shown in 220.

The process may then proceed to step 230 where each value in the series of logarithmically encoded data values may then be transformed into a linear encoding and added to the accumulator. Rather than transform each logarithmically encoded data value directly, the process may instead subtract the offset value determined in step 220 from each of the logarithmically encoded data value before transformation, thus preventing possible out-of-range conditions. The resulting transformed linear encoded values may then be added to the accumulator.

Once all logarithmically encoded data values are transformed using the offset value and added to the accumulator, for example using the logarithmic adder 141 as shown in FIG. 1, the process may then proceed to step 240 where the linearly encoded value stored in the accumulator may be transformed into a logarithmically encoded value and the offset value determined in step 220 added to the logarithmically encoded accumulator value to generate a logarithmically encoded summation of the series of logarithmically encoded data values. The process is then complete.

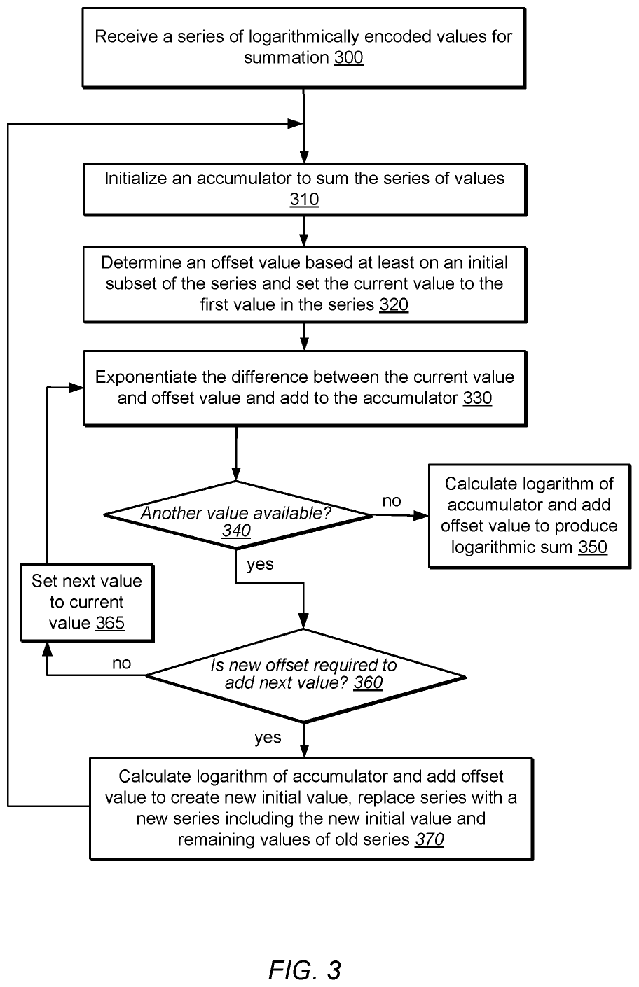

FIG. 3 is a flow diagram illustrating another embodiment of an improved method of implementing summation of a series of logarithmically encoded data values. The process begins at step 300 where a series of logarithmically encoded data values may be received for summation, such as the logarithmically encoded data 135 as shown in FIG. 1. For example, a series of logarithmically encoded data values may be taken from a larger set of logarithmically encoded values (e.g., at least some of a larger series of logarithmically encoded data values), in some embodiments, or a series may be a complete set of logarithmically encoded values, in other embodiments. The process then initializes an accumulator, such as the accumulator 142 as shown in FIG. 1, as shown in step 310 in some embodiments. As logarithmically encoded values may not be directly added, each logarithmically encoded value in the series may first be transformed into a linearly encoded value before being added to the sum.

These transformations, however, may result in out-of-range errors due to the relatively limited numeric range of the resulting linearly encoded values, and subsequent summation may also result in similar out-of-range errors. Instead, at least one offset value, such as the logarithmic offset value 144 as shown in FIG. 1, may be determined, for example by the logarithmic offset manager 143 of FIG. 1.

Rather than selecting the highest valued, or maximum value, of the series of logarithmically encoded data values and assigning the offset value to that maximum value, such as disclosed in step 220 of FIG. 2, the process may instead determine an offset value based on an initial subset of the series of logarithmically encoded data values, wherein one or more of the series of logarithmically encoded data values are not included in the initial subset, as shown in 320. In some embodiments, the offset value may be set to the maximum value of the initial subset while in other embodiments the offset value may be set based only in part on the maximum value of the initial subset. For example, in some embodiments the offset value may be set to have an exponent determined according to the exponent of the maximum value of the initial subset but with a fractional value differing from the fractional value of the maximum value of the initial subset. Choosing an offset value according to the exponent of the maximum value of the initial subset may allow some embodiments to more efficiently implement a logarithmic offset manager, such as the logarithmic offset manager 143 as shown in FIG. 1.

Furthermore, various embodiments may employ different numbers of logarithmically encoded data values in the initial subset of the series. For example, in some embodiments only a portion of the series of logarithmically encoded data values may be present in memory, such as the logarithmically encoded data 135 in memory 130 as shown in FIG. 1, at any given time. In this case, limiting the initial subset of the series to only a portion of the series initially present in memory may improve performance of the summation. In other embodiments, the initial subset of the series may be limited in size according to a specific configuration of the processor, cache and memory subsystem in order to mitigate degradation of the cache and memory subsystem. In still other embodiments, the initial subset of the series may be limited to only a small number of data values, even only a single data value, in order to minimize the execution time or the custom circuitry of the logarithmic offset manager. Furthermore, different number of data values in the initial subset of the series may be chosen according to pre-existing knowledge of the data within the series in order to optimize the performance of the offset determination step in relation to the performance of other steps within the process. These various examples, however, are not intended to be limiting and any number of arrangements of the initial subset may be envisioned. Once the offset value is determined, a current value is set to the first value in the series of logarithmically encoded data values and the process may proceed to step 330.

As shown in 330, the current value of the series may then be transformed into a linear encoding and added to the accumulator. Rather than transform the logarithmically encoded data value directly, the process may instead subtract the offset value determined in step 320 from the logarithmically encoded data value before transformation, thus preventing a possible out-of-range condition. The resulting transformed linear encoded value may then be added to the accumulator.

After the current logarithmically encoded data value is transformed using the offset value and added to the accumulator, for example using the logarithmic adder 141 as shown in FIG. 1, the process may then proceed to step 340 where it may be determined if any logarithmically encoded data values remain to be added to the accumulator.

If no logarithmically encoded data values remain to be added to the accumulator, as indicated by a negative exist from step 340, the process may proceed to step 350 where the linearly encoded value stored in the accumulator may be transformed into a logarithmically encoded value and the offset value determined in step 320 added to the logarithmically encoded accumulator value to generate a logarithmically encoded summation of the series of logarithmically encoded data values. The process is then complete.

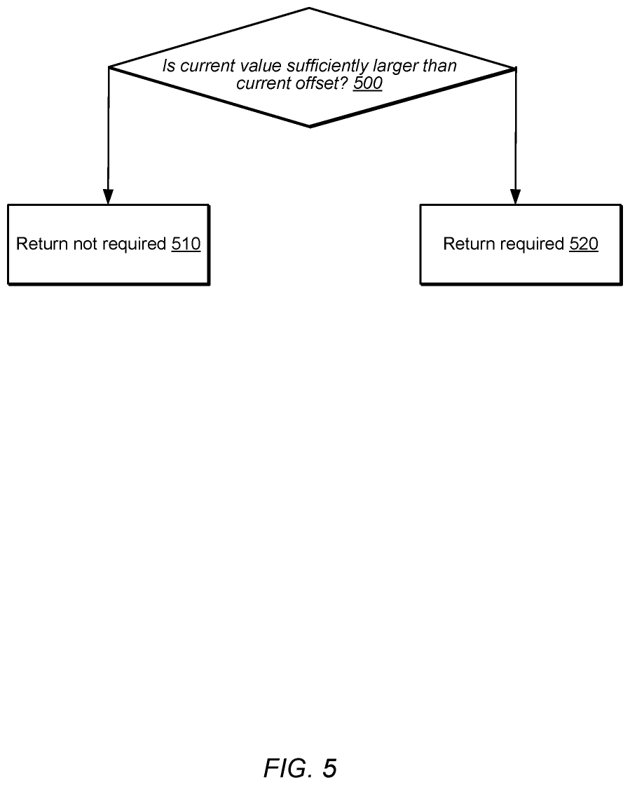

If, however, logarithmically encoded data values remain to be added to the accumulator, as indicated by a negative exit from step 340, the process may proceed to step 360 where it may be determined if a new offset value will be used to add the next logarithmically encoded data value to the accumulator. The determination is discussed in further detail below in FIG. 5 and may be performed, for example, in the logarithmic offset manager such as the logarithmic offset manager 143 as shown in FIG. 1.

If a new offset value is not used to add the next logarithmically encoded data value to the accumulator, as indicated by a negative exit from step 360, the process may proceed to step 365 where the current value is set to the next value in the series of logarithmically encoded data values and the process returns to step 330.

If, however, a new offset value is used to add the next logarithmically encoded data value to the accumulator, as indicated by a positive exit from step 360, the process may proceed to step 370 where the linearly encoded value stored in the accumulator may be transformed into a logarithmically encoded value and the offset value determined in step 320 added to the logarithmically encoded accumulator value to generate a logarithmically encoded partial summation. This partial summation may then be used as an initial value of a new series that further includes the remaining logarithmically encoded data values not yet added to the summation. The new series of logarithmically encoded data values may then replace the current series of logarithmically encoded data values and the process returns to step 310.

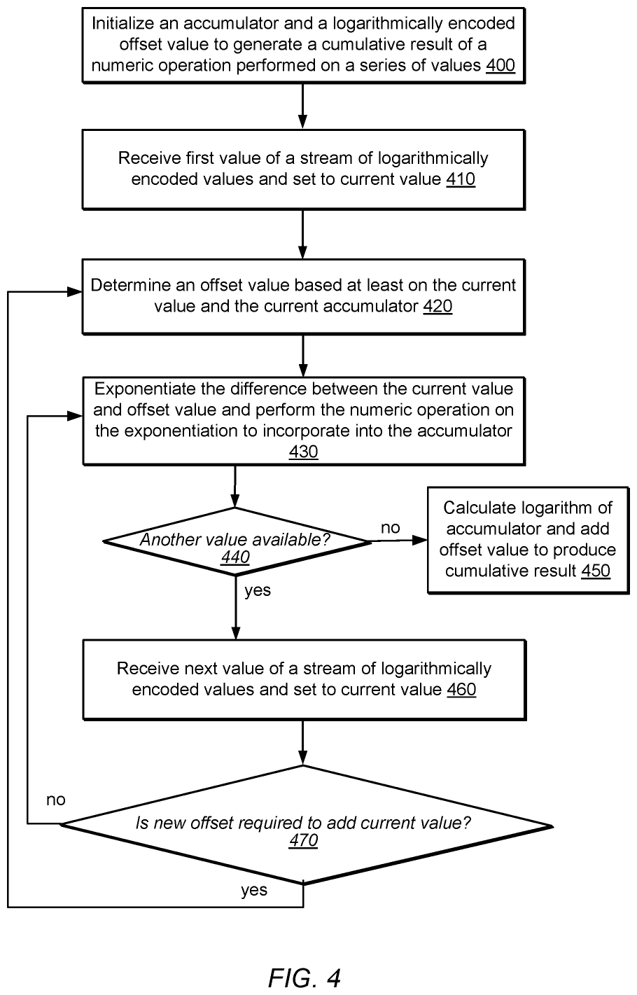

FIG. 4 is a flow diagram illustrating an embodiment of an improved method of implementing numeric operations on a stream of logarithmically encoded data values. Examples of such numeric operations may be addition, subtraction, multiplication and division in various embodiments, although these examples are not intended to be limiting and any number of numeric operations may be envisioned. Such numeric operations may, in some embodiments, satisfy the following conditions:

1. f(a,b)/c=f(a/c, b/c) for all a, b, c>0.

2. For all a,b>0, f (a,b)>0.

where f is the numeric operation.

The process begins at step 400 where an accumulator, such as the accumulator 142 as shown in FIG. 1, and an offset value, such as the logarithmic offset value 144 as shown in FIG. 1, may be initialized with a suitable value. As shown in 410, a first value in the stream of logarithmically encoded data values may then be received. As numeric operations in some embodiments may not directly be applied to logarithmically encoded values, each logarithmically encoded value in the stream may first be transformed into a linearly encoded value.

These transformations, however, may not be directly performed as transformations into linearly encoded values, which could result in out-of-range conversion errors due to the relatively limited numeric range of the resulting linearly encoded values, and subsequent numeric operations may also result in similar out-of-range errors. Instead, at least one offset value, such as the logarithmic offset value 144 as shown in FIG. 1, may be determined, for example by the logarithmic offset manager 143 of FIG. 1.

Once the first value in the stream has been received and the current value set to the initial value, the process may advance to step 420. As shown in 420, the process may determine an offset value based on the current value, the current accumulator value and the existing offset value. First, the linearly encoded value stored in the accumulator may be transformed into a logarithmically encoded value and the current offset value added to the logarithmically encoded accumulator value to generate a logarithmically encoded partial result, in some embodiments. The offset value may be set to the maximum value of the logarithmically encoded current value and the logarithmically encoded partial result while in other embodiments the offset value may be set based only in part on the maximum value of the logarithmically encoded current value and the logarithmically encoded partial result. For example, in some embodiments the offset value may be set to have an exponent determined according to the exponent of the maximum value of the logarithmically encoded current value and the logarithmically encoded partial result but with a fractional value differing from the fractional value of the maximum value of the logarithmically encoded current value and the logarithmically encoded partial result. Choosing an offset value according to the exponent of the maximum value of the current value and the current accumulator value may allow some embodiments to more efficiently implement a logarithmic offset manager, such as the logarithmic offset manager 143 as shown in FIG. 1. Once the offset value is determined, the process may proceed to step 430.

As shown in 430, the current value of the stream may then be transformed into a linear encoding and added to the accumulator. Rather than transform the logarithmically encoded data value directly, the process may instead subtract the offset value determined in step 420 from the logarithmically encoded data value before transformation, thus preventing a possible out-of-range condition. The resulting transformed linear encoded value may then be applied to the accumulator using the numeric operation.

After the current logarithmically encoded data value is transformed using the offset value and added to the accumulator, for example using the logarithmic adder 141 as shown in FIG. 1, the process may then proceed to step 440 where it may be determined if any logarithmically encoded data values of the stream remain to be added to the accumulator.

If no logarithmically encoded data values remain to be added to the accumulator, as indicated by a negative exist from step 440, the process may proceed to step 450 where the linearly encoded value stored in the accumulator may be transformed into a logarithmically encoded value and the offset value determined in step 420 added to the logarithmically encoded accumulator value to generate a logarithmically encoded result for the series of logarithmically encoded data values. The process is then complete.

If, however, logarithmically encoded data values remain to be added to the accumulator, as indicated by a negative exit from step 440, the process may proceed to step 460 where the next logarithmically encoded data value of the stream may be received and set to the current value, in some embodiments. Then, as shown in 470, it may be determined if a new offset value will be required to incorporate the next logarithmically encoded data value into the accumulator. The determination is discussed in further detail below in FIG. 5 and may be performed, for example, in the logarithmic offset manager such as the logarithmic offset manager 143 as shown in FIG. 1.

If a new offset value is not required to incorporate the next logarithmically encoded data value into the accumulator, as indicated by a negative exit from step 470, the process may proceed to step 430. If, however, a new offset value is required to incorporate the next logarithmically encoded data value into the accumulator, as indicated by a positive exit from step 470, the process may return to step 420.

FIG. 5 is a flow diagram illustrating various embodiments of a method for determining if a new offset value is used for summation. Various embodiments of this method may be implemented in a logarithmic offset manager, such as the logarithmic offset manager 143 as shown in FIG. 1, using either general purpose instructions or custom instructions of executable code running on processors of a system, such as the executable code 131 executing on processor(s) 110 of system 100 as shown in FIG. 1, or as executable code optimized to execute on coprocessors, such as the coprocessor(s) 120 as shown in FIG. 1 or the accelerator(s) 680 or graphics processing Units (GPUs) 690 as discussed below in FIG. 6. Additional embodiments may be implemented at least in part using custom circuitry or programmable logic, for example using Field Programmable Gate Arrays (FPGAs), such as coprocessor(s) 120 as shown in FIG. 1 or the accelerator(s) 680 discussed below in FIG. 6. Such example embodiments are not intended to be limiting and any number of embodiments may be envisioned.

The process begins at step 500 where a determination is made whether a current logarithmically encoded value is sufficiently larger than the current offset value. If the, a current logarithmically encoded value is sufficiently larger than the current offset value the process advances to step 520 where an indication that a new offset value is used may be returned. If, however, a current logarithmically encoded value is not sufficiently larger than the current offset value the process advances to step 510 where an indication that a new offset value is not used may be returned.

To determine whether a current logarithmically encoded value is sufficiently larger than the current offset value, a number of factors may be considered, in various environments. First, a determination may be made whether an exponentiation of a difference between the current logarithmically encoded value and the current offset value would result in an out-of-range conversion error dependent on the format used. In some embodiments, this determination may be made by comparing a difference between the current logarithmically encoded value and the current offset value to a threshold value to determine if the difference exceeds the threshold value. In some embodiments, this threshold value may be set according to an out-of-range condition dependent on the format used. In other embodiments, only an exponent field of floating point representations of the current logarithmically encoded value and the current offset value may be considered, where a current exponent value of the summation may be tracked by the logarithmic offset manager to prevent out-of-range conditions. Restricting consideration of the current logarithmically encoded value and the current offset value to only the exponent portions of the floating point representations may simplify the implementation of the logarithmic offset manager and improve performance, in some embodiments.

In addition, in some embodiments the determination may also consider of out-of-range conditions resulting from the addition of subsequent linearly encoded values. In some embodiments, this consideration may contribute to the selection of threshold value discussed above. These various factors are not intended to be limiting, and various approaches to determining whether a current logarithmically encoded value is sufficiently larger than the current offset value may be envisioned.

The methods described herein may in various embodiments be implemented by any combination of hardware and software. For example, in one embodiment, the methods may be implemented on or across one or more computer systems (e.g., a computer system as in FIG. 6) that includes one or more processors executing program instructions stored on one or more computer-readable storage media coupled to the processors. The program instructions may implement the functionality described herein (e.g., the functionality of various servers and other components that implement the network-based virtual computing resource provider described herein). The various methods as illustrated in the figures and described herein represent example embodiments of methods. The order of any method may be changed, and various elements may be added, reordered, combined, omitted, modified, etc.

Some of the mechanisms described herein may be provided as a computer program product, or software, that may include a non-transitory, computer-readable storage medium having stored thereon instructions which may be used to program a computer system 600 (or other electronic devices) to perform a process according to various embodiments. A computer-readable storage medium may include any mechanism for storing information in a form (e.g., software, processing application) readable by a machine (e.g., a computer). The machine-readable storage medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; electrical, or other types of medium suitable for storing program instructions. In addition, program instructions may be communicated using optical, acoustical or other form of propagated signal (e.g., carrier waves, infrared signals, digital signals, etc.)

In various embodiments, computer system 600 may include one or more processors 610; each may include multiple cores, any of which may be single- or multi-threaded. For example, multiple processor cores may be included in a single processor chip (e.g., a single processor 610), and multiple processor chips may be included in computer system 600. Each of the processors 610 may include a cache or a hierarchy of caches, in various embodiments. For example, each processor chip 610 may include multiple L1 caches (e.g., one per processor core) and one or more other caches (which may be shared by the processor cores on a single processor).

The computer system 600 may also include one or more graphics processing units (GPUs) 690 capable of executing floating point operations suitable for implementing some or all aspects of the embodiments described herein. Various embodiments may implement all or portions of these methods using software executing on these GPUs alone or in combination with other elements of the computer system 600.

The computer system 600 may also include one or more accelerators 680 implementing some or all aspects of the embodiments described herein. These accelerators may be implemented in custom circuitry or programmable logic devices, such as Field Programmable Gate Arrays (FPGAs). Various embodiments may implement all or portions of these methods using these accelerators alone or in combination with other elements of the computer system 600.

The computer system 600 may also include one or more storage devices 670 (e.g. optical storage, magnetic storage, hard drive, tape drive, solid state memory, etc.) and one or more system memories 610 (e.g., one or more of cache, SRAM, DRAM, RDRAM, EDO RAM, DDR RAM, SDRAM, Rambus RAM, EEPROM, etc.). In some embodiments, one or more of the storage device(s) 670 may be implemented as a module on a memory bus (e.g., on I/O interface 630) that is similar in form and/or function to a single in-line memory module (SIMM) or to a dual in-line memory module (DIMM). Various embodiments may include fewer or additional components not illustrated in FIG. 6 (e.g., video cards, audio cards, additional network interfaces, peripheral devices, a network interface such as an ATM interface, an Ethernet interface, a Frame Relay interface, etc.)

The one or more processors 610, the storage device(s) 670, and the system memory 620 may be coupled to the system interconnect 630. The system memory 620 may contain application data 626 and program code 625. Application data 626 may contain various data structures while program code 625 may be executable to implement one or more applications, shared libraries, and/or operating systems.

Program instructions 625 may be encoded in platform native binary, any interpreted language such as Java™ byte-code, or in any other language such as C/C++, the Java™ programming language, etc., or in any combination thereof. In various embodiments, applications, operating systems, and/or shared libraries may each be implemented in any of various programming languages or methods. For example, in one embodiment, operating system may be based on the Java programming language, while in other embodiments it may be written using the C or C++ programming languages. Similarly, applications may be written using the Java programming language, C, C++, or another programming language, according to various embodiments. Moreover, in some embodiments, applications, operating system, and/shared libraries may not be implemented using the same programming language. For example, applications may be C++ based, while shared libraries may be developed using C.

Although the embodiments above have been described in considerable detail, numerous variations and modifications will become apparent to those skilled in the art once the above disclosure is fully appreciated. For example, although many of the embodiments are described in terms of particular types of operations that support synchronization within multi-threaded applications that access particular shared resources, it should be noted that the techniques and mechanisms disclosed herein for accessing and/or operating on shared resources may be applicable in other contexts in which applications access and/or operate on different types of shared resources than those described in the examples herein. It is intended that the following claims be interpreted to embrace all such variations and modifications.

What is claimed:

1. A system, comprising:
at least one processor; and
a memory, storing program instructions that when executed by the at least one processor cause the at least one processor to:
receive a series of values for summation, wherein individual values in the series of values are logarithmically encoded;
select a first offset value based on an initial subset of the series of values, wherein a number of values in the initial subset is less than a total number of values in the series of values;
compute a first summation of a first portion of the series of values, wherein to compute the first summation the program instructions that when executed by the at least one processor cause the at least one processor to compute a logarithm of a sum of respective exponentiations of respective differences between individual elements of the first portion of the series of values and the selected first offset value, the first portion of the series of values ranging from a first value of the series of values to a second value of the series of values, and wherein the second value is selected based on determining that a next value of the series of values immediately after the second value cannot be included in the first summation using the selected first offset value;
select a second offset value based at least on the first summation; and
compute a summation of the series of values, wherein to compute the first summation the program instructions that when executed by the at least one processor cause the at least one processor to compute a logarithm of a sum of respective exponentiations of respective differences between individual elements of the first summation and a remaining portion of the series of values and the selected second offset value, the remaining portion of the series ranging from the next value of the series of values to a last value of the series of values.

2. The system of claim 1, wherein to determine that the next value of the series of values immediately after the second value cannot be included in the first summation, the program instructions that when executed by the at least one processor cause the at least one processor to determine that including the next value using the selected first offset value would result in an overflow or underflow of an exponentiation or summing operation.

3. The system of claim 1, further storing program instructions that when executed by the at least one processor cause the at least one processor to select the first offset value based at least in part on an evaluation of a consecutive plurality of values of the series values to identify a value of the series of values as having a greatest value of the consecutive plurality of values.

4. The system of claim 1, further storing program instructions that when executed by the at least one processor cause the at least one processor to identify the next value of the series of values based on determining that the summing of the respective exponentiations of the respective differences between individual elements of the first portion of the series of values and the selected first offset value exceeds a threshold.

5. The system of claim 1, wherein the initial subset of the series of values comprises a first value of the series of values, wherein the number of values in the initial subset is one value, and wherein the first offset value is selected according to the first value of the series of values.

6. The system of claim 1, wherein selecting the first offset value, computing the first summation, selecting the second offset and computing the summation of the series of values is performed as individual elements of the series of values are received.

7. A computer implemented method comprising:
receiving a series of values, wherein each of the series of values is logarithmically encoded;
selecting a first offset value based on the values of an initial subset of the series of values, wherein a number of values in the initial subset is less than a total number of values in the series of values;
computing a first result for a first portion of the series of values comprising computing a logarithm of a cumulative result of numeric operations performed on respective exponentiations of respective differences between individual elements of the first portion of the series of values and the selected first offset value, the first portion of the series of values ranging from a first value of the series of values to a second value of the series of values, wherein the second value is selected based on determining that a next value of the series of values immediately after the second value cannot be included in the first cumulative result of numeric operations using the selected first offset value;
selecting a second offset value based on at least the first summation; and
computing a result for the series of values comprising computing a logarithm of a cumulative result of respective exponentiations of numeric operations on respective differences between individual elements of the first summation and a remaining portion of the series of values and the selected second offset value, the remaining portion of the series ranging from the next value of the series of values to a last value of the series of values.

8. The method of claim 7, wherein determining that the next value of the series of values immediately after the second value cannot be included in the first cumulative result of numeric operations comprises determining that including the next value using the selected first offset value would result in an overflow or underflow of an exponentiation or of the numeric operation.

9. The method of claim 7, further comprising selecting the first offset value based on an evaluation of a consecutive plurality of values of the series values to identify a value of the series of values as having a greatest value of the consecutive plurality of values.

10. The method of claim 7, further comprising identifying the next value of the series of values based on determining that the cumulative result of numeric operations on the respective exponentiations of the respective differences between individual elements of the first portion of the series of values and the selected first offset value exceeds a threshold.

11. The method of claim 7 wherein the initial subset of the series of values comprises a first value of the series of values, wherein the number of values in the initial subset is one value, and wherein the first offset value is selected according to the first value of the series of values.

12. The method of claim 7, wherein selecting the first offset value, computing the first result, selecting the second offset and computing the result of the series of values is performed as individual elements of the series of values are received.

13. The method of claim 7, wherein the first offset value is less than the maximum value of the initial subset of the series of values.

14. One or more non-transitory computer-accessible storage media storing program instructions that when executed on or across one or more computing devices cause the one or more computing devices to perform:
receiving for summation a series of values, wherein each of the series of values is logarithmically encoded;
selecting a first offset value based on the values of an initial subset of the series of values, wherein a number of values in the initial subset is less than a total number of values in the series of values;
computing a first summation of a first portion of the series of values comprising computing a logarithm of a summing of respective exponentiations of respective differences between individual elements of the first portion of the series of values and the selected first offset value, the first portion of the series of values ranging from a first value of the series of values to a second value of the series of values, wherein the second value is selected based on determining that a next value of the series of values immediately after the second value cannot be included in the first summation using the selected first offset value;
selecting a second offset value based on at least the first summation; and
computing a summation of the series of values comprising computing a logarithm of a summing of respective exponentiations of respective differences between individual elements of the first summation and a remaining portion of the series of values and the selected second offset value, the remaining portion of the series ranging from the next value of the series of values to a last value of the series of values.

15. The one or more non-transitory computer-accessible storage media of claim 14, wherein determining that the next value of the series of values immediately after the second value cannot be included in the first summation comprises determining that including the next value using the selected first offset value would result in an overflow or underflow of an exponentiation or summing operation.

16. The one or more non-transitory computer-accessible storage media of claim 14, further storing instructions that when executed on or across one or more computing devices cause the one or more computing devices to perform selecting the first offset value based on an evaluation of a consecutive plurality of values of the series values to identify a value of the series of values as having a greatest value of the consecutive plurality of values.

17. The one or more non-transitory computer-accessible storage media of claim 14, further storing instructions that when executed on or across one or more computing devices cause the one or more computing devices to perform identifying the next value of the series of values based on determining that the summing of the respective exponentiations of the respective differences between individual elements of the first portion of the series of values and the selected first offset value exceeds a threshold.

18. The one or more non-transitory computer-accessible storage media of claim 14, wherein the initial subset of the series of values comprises a first value of the series of values, wherein the number of values in the initial subset is one value, and wherein the first offset value selected according to the first value of the series of values.

19. The one or more non-transitory computer-accessible storage media of claim 14, wherein selecting the first offset value, computing the first summation, selecting the second offset and computing the summation of the series of values is performed as individual elements of the series of values are received.

20. The one or more non-transitory computer-accessible storage media of claim 14, wherein the first offset value is less than the maximum value of the initial subset of the series of values.
